(19) United States
(12) Patent Application Publication
(10) Pub. No.: US 2019/0153889 A1
(43) Pub. Date: May 23, 2019

(54) SYSTEMS AND METHODS FOR A VARIABLE GEOMETRY TURBINE NOZZLE ACTUATION

(71) Applicant: Ford Global Technologies, LLC, Dearborn, MI (US)

(72) Inventors: Leon Hu, Bloomfield Hills, MI (US); Dengfeng Yang, Beijing (CN); Ben Zhao, Beijing (CN); Jianwen James Yi, West Bloomfield, MI (US)

(21) Appl. No.: 15/821,428

(22) Filed: Nov. 22, 2017

(51) Int. Cl. F01D 17/16; F01D 9/04; F02B 37/24

(52) U.S. Cl. CPC F01D 17/167; F01D 9/041; Y10S 903/902; F05D 2240/128; F05D 2220/40; F02B 37/24

(57) ABSTRACT

Methods and system are provided for a turbine nozzle adapted with variable geometry guide vanes. In one example, a turbine nozzle may include sliding and fixed vanes arranged between supporting plates. The sliding vanes are engaged by an actuating plate that adjusts a position of the sliding vanes to regulate gas flow to the turbine.

### FIELD

The present application relates to variable geometry turbines for turbochargers of internal combustion engines.

### BACKGROUND AND SUMMARY

Engines may use a turbocharger to improve engine torque and/or power output density. A turbocharger may include a turbine disposed in line with the engine's exhaust stream, and coupled via a drive shaft to a compressor disposed in line with the engine's intake air passage. The exhaust-driven turbine may then supply energy, via the drive shaft, to the compressor to boost the intake air pressure. In this way, the exhaust-driven turbine supplies energy to the compressor to boost the pressure and flow of air into the engine. Therefore, increasing the rotational speed of the turbine may increase boost pressure. The desired amount of boost may vary over operation of the engine. For example, the desired boost may be greater during acceleration than during deceleration.

One solution to control the boost pressure is the use of a variable geometry turbine in the turbocharger. A variable geometry turbine controls boost pressure by varying the flow of exhaust gas through the turbine. For example, exhaust gas may flow from the exhaust manifold through a turbine nozzle and to the turbine blades. The geometry of the turbine nozzle may be varied to control the angle that exhaust gas contacts the turbine blades and/or to vary the cross-sectional area of inlet passages, or throat, upstream of the turbine blades. Increasing the cross-sectional area of the inlet passages may allow more gas to flow through the passages. Furthermore, the angle of incidence of gas flowing across the turbine blades may affect the efficiency of the turbine, e.g., the amount of thermodynamic energy captured from the flow that is converted to mechanical energy. Thus, the turbine speed and boost pressure may be varied by changing the geometry of the turbine nozzle.

The design of variable geometry turbines has been modified to yield various desirable results. For example, U.S. Patent Application 2013/0042608 by Sun et al. discloses systems and methods to vary the angle of incidence of gas flowing across the turbine blade by adjusting the cross-sectional area of the passages between adjacent nozzle vanes. Herein, an annular turbine nozzle is provided having a central axis and a number of nozzle vanes. Each nozzle vane comprises a stationary vane and a sliding vane, wherein the sliding vane includes a surface in sliding contact with a surface of the stationary vane. As such, the nozzle vane may enable a desired angle of incidence and a preferred cross-sectional area of the passages over a range of engine operating conditions. A single support plate with linear slots open to a circumferential edge receives pins attached to the sliding vanes during assembly. A bearing is installed at an end of each pin. A rotatable actuating plate is positioned adjacent the support plate having actuating throughslots to receive the bearings. Movement of the actuating plate effects movement of the sliding vanes.

The inventors herein have recognized potential issues with the approach identified above. For example, the throughslot in the actuation plate allows exhaust gas to pass through the actuation plate. The inventors herein have recognized improved characteristics for the nozzle when the exhaust flow stream is better contained. Further, the arrangement disclosed in 2013/0042608 requires relatively tight tolerances to ensure that the vanes stay in proper location, and move as intended.

The inventors herein have recognized the above issues and have developed an approach to at least partly address them. As one example, a turbine nozzle may be provided that may include fixed vanes, and first and second support plates that may be fixed to opposite ends of the fixed vanes. Throughslot guide slots may be defined in the first support plate, and blind guide slots may be defined in the second support plate. Sliding vanes may each be positioned for sliding engagement with the respective fixed vanes. Each sliding vane may have guide tongues on opposite ends thereof including a first guide tongue for sliding engagement within respective throughslot guide slots and a second guide tongue for sliding engagement within respective blind guide slots. An actuation plate may be disposed adjacent, and configured for movement relative to, the first support plate, and having blind actuation slots that extend in directions different from directions of the guide slots and that cross over the guide slots at movable intersecting points as viewed in a direction normal to the actuation plate. The first guide tongues may each include an actuating pin extending into respective actuation slots at the intersecting points and movable upon movement of the actuation plate relative to the support plates. In this way, the blind slots in the actuation plate and in the second support plate may tend to provide a sealed arrangement in the axial directions. Also in this way, the arrangement shown and described herein may be constructed and operated effectively without overly stringent tolerance requirements.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure. Finally, the above explanation does not admit any of the information or problems were well known.

### BRIEF DESCRIPTION OF THE DRAWINGS

FIG. 1 shows an example embodiment of a turbocharged engine in accordance with the disclosure.

FIG. 2 shows a cross-section of an example embodiment of a turbocharger turbine including a turbine nozzle in accordance with the disclosure.

FIG. 3A is a perspective view illustrating a nozzle vane system comprising fixed vanes and sliding vanes disposed together in an operative position in accordance with the disclosure.

FIG. 3B is a top view illustrating a nozzle vane system comprising fixed vanes and sliding vanes disposed together in an operative position in accordance with the disclosure.

FIG. 3C is a side view illustrating a nozzle vane system comprising fixed vanes and sliding vanes disposed together in an operative position in accordance with the disclosure.

FIG. 4A is a perspective view illustrating first and second support plates of a nozzle vane system in accordance with the disclosure.

FIG. 4B is a top view illustrating first and second support plates of a nozzle vane system in accordance with the disclosure

FIG. 4C is a side view illustrating first and second support plates of a nozzle vane system in accordance with the disclosure.

FIG. 5A is a perspective view of a nozzle vane system illustrating fixed vanes, sliding vanes, first and second support plates, and an actuating plate disposed in an operative arrangement in accordance with the disclosure.

FIG. 5B is a top view of a nozzle vane system illustrating an actuating plate disposed in an operative arrangement in accordance with the disclosure.

FIG. 5C is a side view of a nozzle vane system illustrating fixed vanes, sliding vanes, first support plate, and an actuating plate disposed in an operative arrangement in accordance with the disclosure.

FIG. 6 is an exploded perspective view of an example actuation plate, support plate and sliding vane of a nozzle vane system in accordance with the disclosure.

FIG. 7A is a first schematic top view illustrating example positional relationships with some of the elements in accordance with the disclosure.

FIG. 7B is a second schematic top view illustrating example positional relationships with some of the elements in accordance with the disclosure.

FIG. 8 is a flow diagram illustrating an example method for the operation of a nozzle vane system in accordance with the present disclosure.

### DETAILED DESCRIPTION

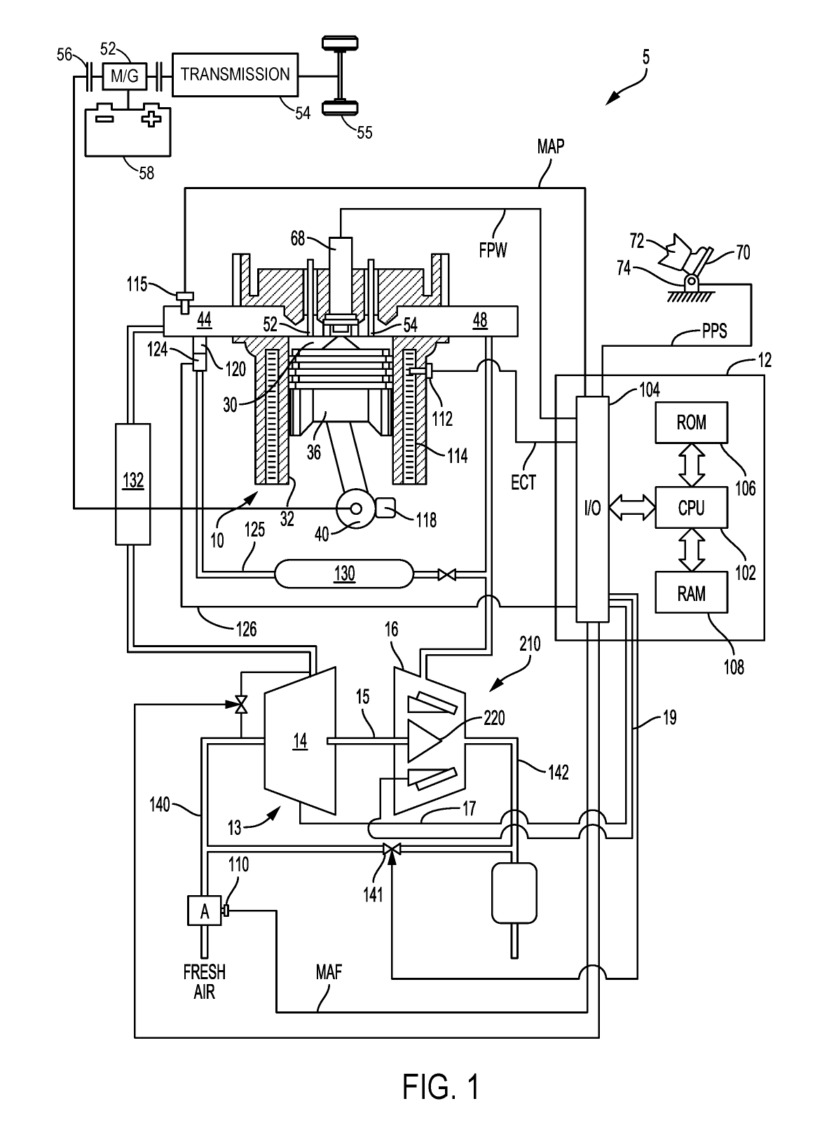

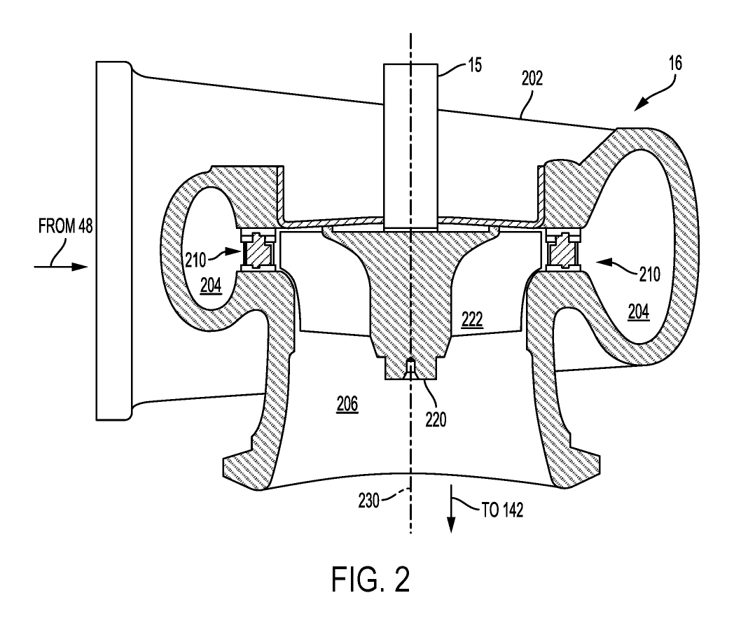

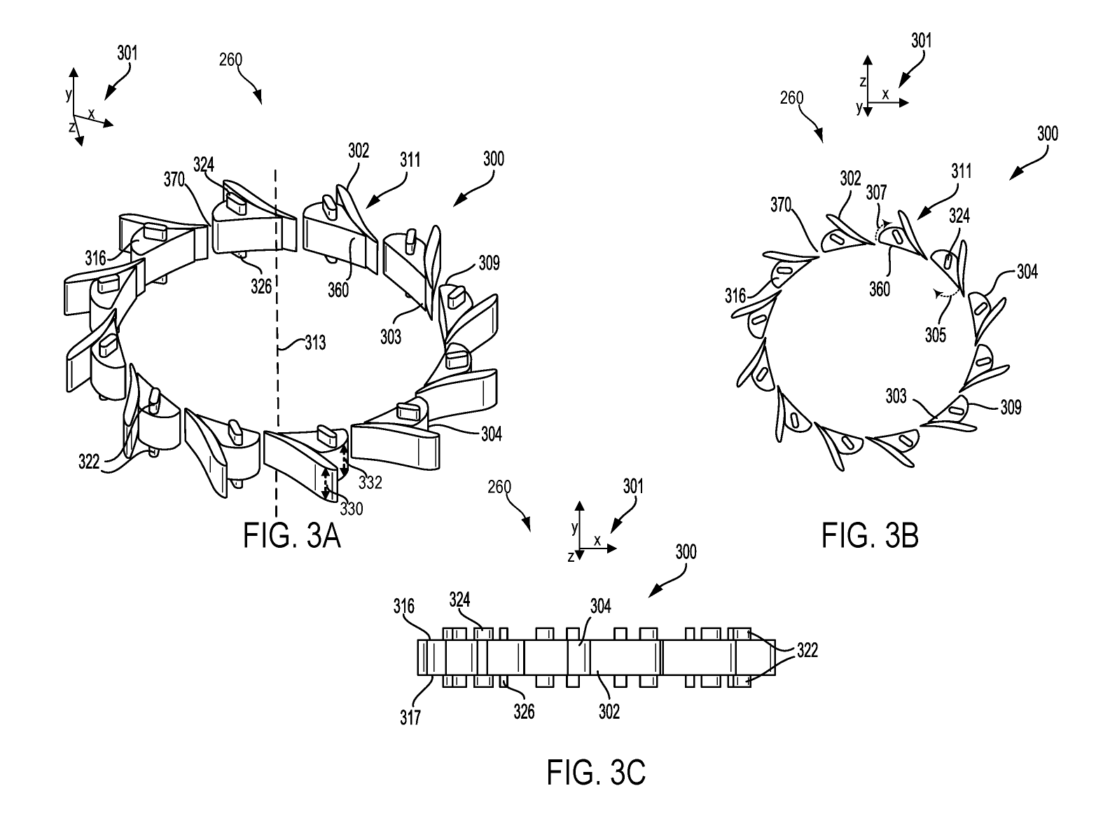

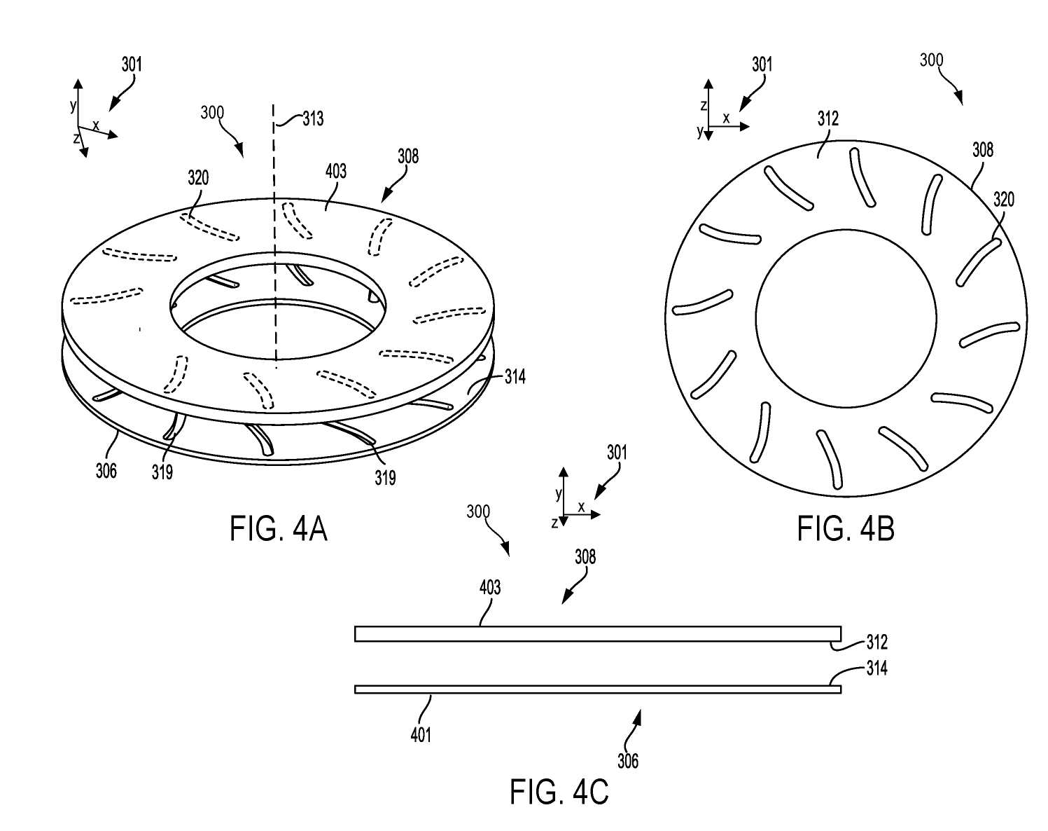

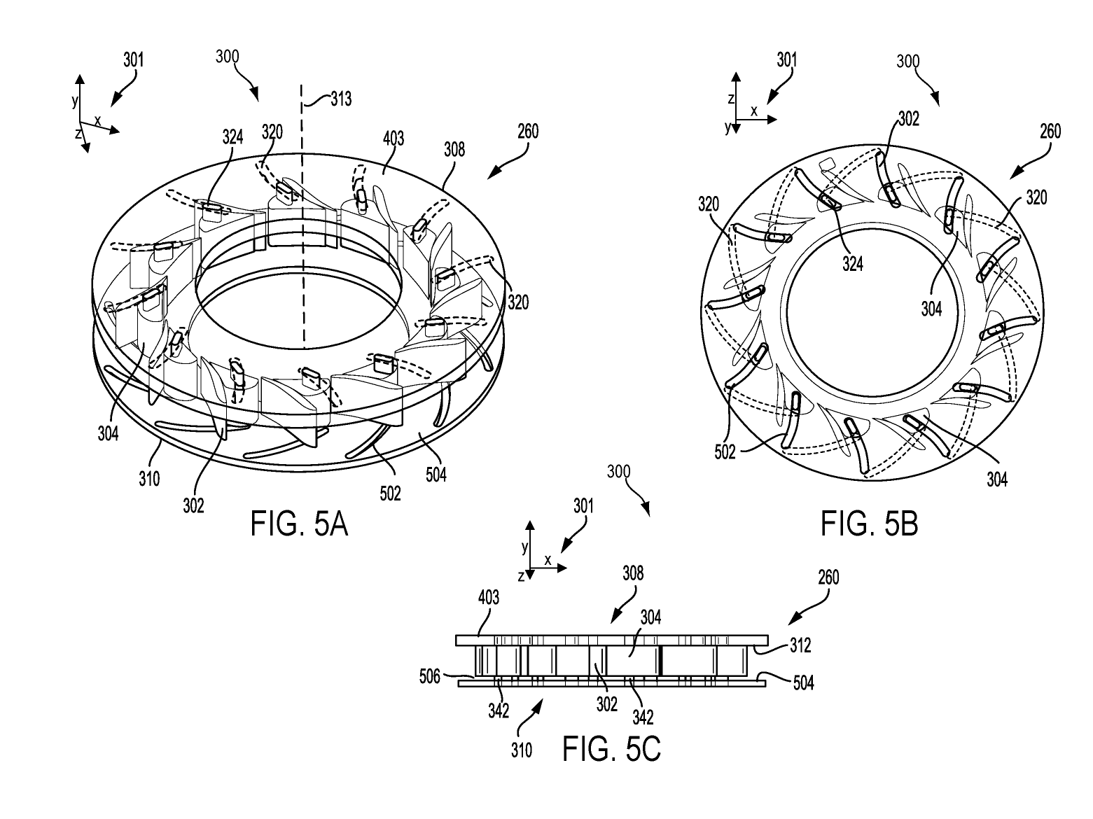

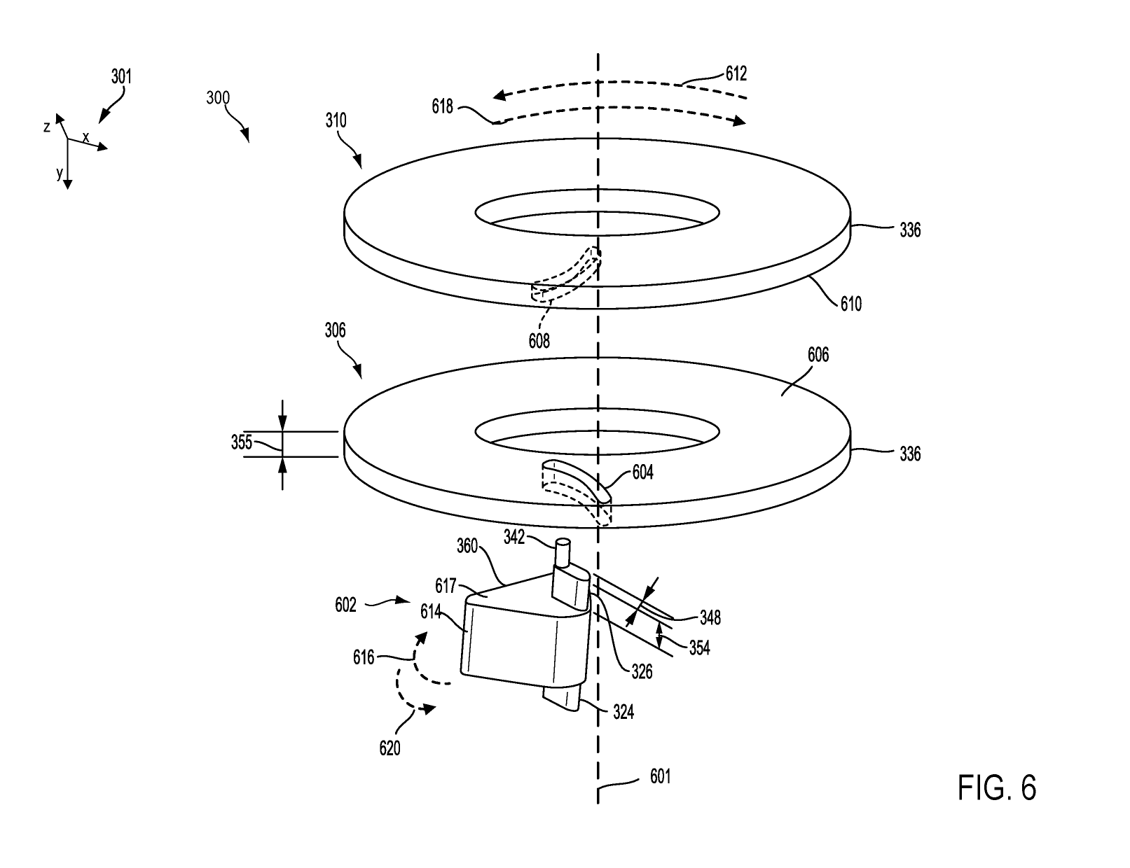

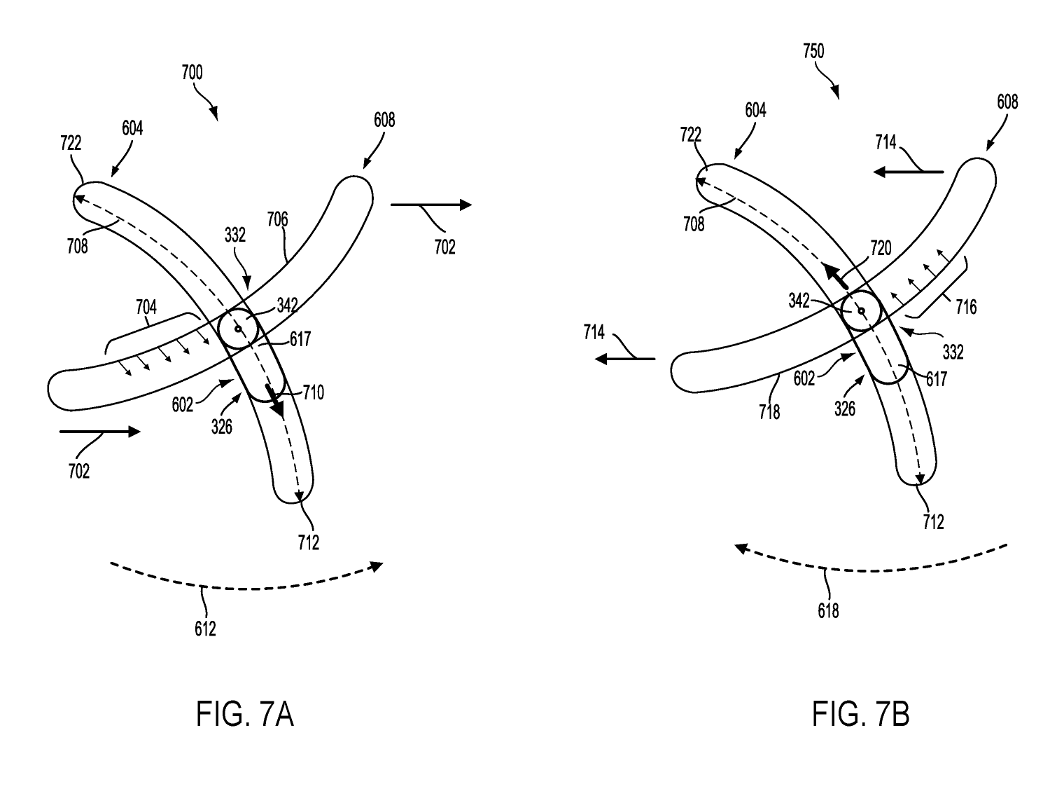

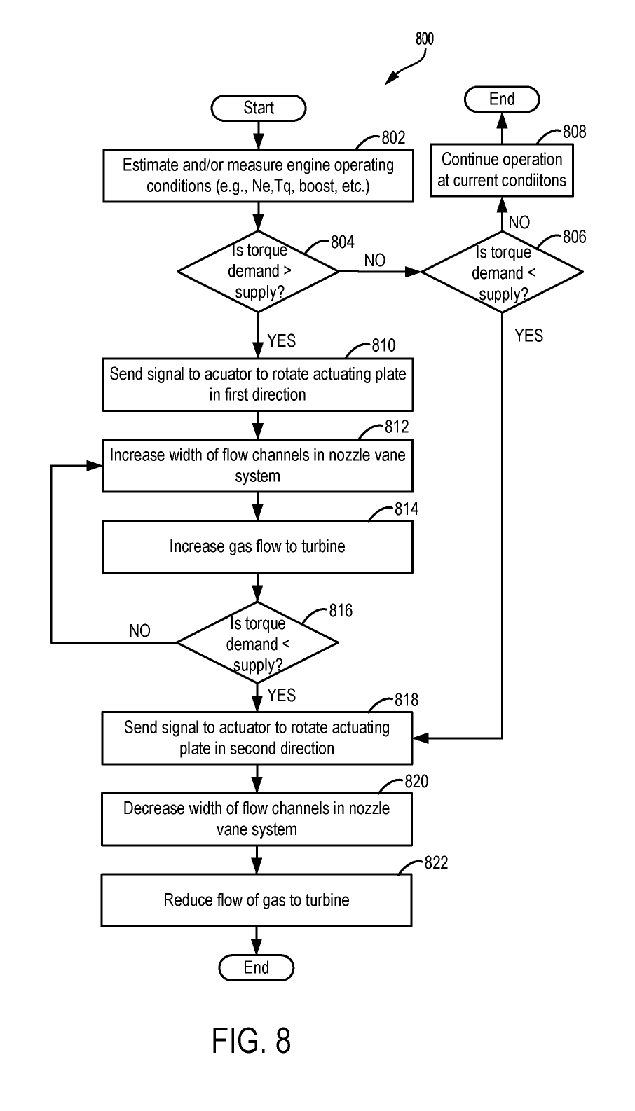

The following description relates to systems and methods for variable geometry turbochargers of internal combustion engines. An example engine with a turbocharger is illustrated in FIG. 1. The example turbocharger includes a compressor driven by a turbine, such as the turbine illustrated in FIG. 2. The turbine may be a variable geometry turbine adapted with a nozzle vane system to regulate gas flow through a turbine nozzle. An example of the nozzle vane system is shown in FIGS. 3A-3C, depicting different views to show the positioning and geometries of a plurality of fixed vanes and sliding vanes. The nozzle vane system may include a first and a second support plate, for which different views are provided in FIGS. 4A-4B, configured to the nozzle vane system. The arrangement of the nozzle vane system including the second support plate and an actuation plate is illustrated in FIGS. 5A-5C. An example of the positioning of the actuation plate relative to the first support plate and and the arrangement of the plurality of sliding vanes within a set of first slots of the first support plate extending into a set of guide slots of the actuation plate is depicted in an exploded view of FIG. 6. FIG. 7 is a schematic showing a detailed view from above of the positioning of a pin of a sliding vane relative to a guide slot in the actuating plate and a guiding tongue of the sliding vane inserted through a throughhole slot in the first support plate, illustrating the movement of the pin as guided by the guide slot and throughhole slot as well as a rocking motion of the actuating plate. FIG. 8 is a flow chart describing a method for the controlling gas flow to the turbine through the nozzle vane system. FIG. 1 shows an example of a vehicle 5 configured with a turbocharged engine 10. Specifically, turbocharged engine 10 is an internal combustion engine 10, comprising a plurality of cylinders, also referred to a combustion chambers, one cylinder, or combustion chamber, 30 of which is shown in FIG. 1.

In some examples, vehicle 5 may be a hybrid vehicle with multiple sources of torque available to one or more vehicle wheels 55. In other examples, vehicle 5 is a conventional vehicle with only an engine or an electric vehicle with only an electric machine(s). In the example shown, vehicle 5 includes engine 10 and an electric machine 52. Electric machine 52 may be a motor or a motor/generator. Crankshaft 40 of engine 10 and electric machine 52 are connected via transmission 54 to vehicle wheels 55 when one or more clutches 56 are engaged. In the depicted example, a first clutch 56 is provided between crankshaft 40 and electric machine 52, and a second clutch 56 is provided between electric machine 52 and transmission 54. A controller 12 may send a signal to an actuator of each clutch 56 to engage or disengage the clutch, so as to connect or disconnect crankshaft 140 from electric machine 52 and the components connected thereto, and/or connect or disconnect electric machine 52 from transmission 54 and the components connected thereto. Transmission 54 may be a gearbox, a planetary gear system, or another type of transmission. The powertrain may be configured in various manners including as a parallel, a series, or a series-parallel hybrid vehicle.

Electric machine 52 receives electrical power from a traction battery 58 to provide torque to vehicle wheels 55. Electric machine 52 may also be operated as a generator to provide electrical power to charge battery 58, for example, during a braking operation.

Engine 10 may be controlled at least partially by a control system including controller 12 and by input from a vehicle operator 72 via an input device 70. In one example, input device 70 may be an accelerator pedal and a pedal position sensor 74 for generating a proportional pedal position signal PPS. Engine 10 includes combustion chamber 30 and cylinder walls 32 with piston 36 positioned therein and connected to crankshaft 40. Combustion chamber 30 communicates with intake manifold 44 and exhaust manifold 48 via respective intake valve 52 and exhaust valve 54. Intake manifold 44 is also shown having fuel injector 68 coupled thereto for delivering fuel in proportion to the pulse width of a signal (FPW) from controller 12.

Controller 12 is shown in FIG. 1 as a microcomputer, including microprocessor 102, input/output ports 104, an electronic storage medium for executable programs and calibration values shown as read only memory chip 106 in this particular example, random access memory 108, keep alive memory 110, and a data bus. Controller 12 may receive various signals from sensors coupled to engine 10, in addition to those signals previously discussed, including measurement of inducted mass air flow (MAF) from mass air flow sensor 115; engine coolant temperature (ECT) from temperature sensor 112 coupled to cooling sleeve 114; a profile ignition pickup signal (PIP) from Hall effect sensor 118 (or other type) coupled to crankshaft 40; throttle position (TP) from a throttle position sensor; and absolute manifold pressure signal, MAP, from sensor 122. Engine speed signal, RPM, may be generated by controller 12 from signal PIP. Further, controller 12 may estimate a compression ratio of the engine based on measurements from a pressure transducer positioned in the cylinder 30 (not shown).

The controller 12 receives signals from the various sensors of FIG. 1 and employs the various actuators of FIG. 1 to adjust engine operation based on the received signals and instructions stored on a memory of the controller.

Storage medium read-only memory 106 can be programmed with computer readable data representing instructions executable by processor 102 for performing the methods.

In a configuration known as high pressure EGR, exhaust gas is delivered to intake manifold 44 by EGR tube 125 communicating with exhaust manifold 48. EGR valve assembly 120 is located in EGR tube 125. Stated another way, exhaust gas travels from exhaust manifold 48 first through valve assembly 120, then to intake manifold 44. EGR valve assembly 120 can then be said to be located upstream of the intake manifold. There is also an optional EGR cooler 130 placed in EGR tube 125 to cool EGR before entering the intake manifold. Low pressure EGR may be used for recirculating exhaust gas from downstream of turbine 16 to upstream of compressor 14 via valve 141.

Pressure sensor 115 provides a measurement of manifold pressure (MAP) to controller 12. EGR valve assembly 120 has a valve position (not shown) for controlling a variable area restriction in EGR tube 125, which thereby controls EGR flow. EGR valve assembly 120 can either minimally restrict EGR flow through tube 125 or completely restrict EGR flow through tube 125, or operate to variably restrict EGR flow. Vacuum regulator 124 is coupled to EGR valve assembly 120. Vacuum regulator 124 receives an actuation signal 126 from controller 12 for controlling valve position of EGR valve assembly 120. In one embodiment, EGR valve assembly 120 is a vacuum actuated valve. However, any type of flow control valve may be used, such as, for example, an electrical solenoid powered valve or a stepper motor powered valve.

Turbocharger 13 has a turbine 16 coupled to exhaust manifold 48 and a compressor 14 coupled in the intake manifold 44 via an intercooler 132. Turbine 16 includes a turbine nozzle 210 and a turbine wheel 220 and is coupled to compressor 14 via a drive shaft 15. Air at atmospheric pressure enters compressor 14 from passage 140. Exhaust gas flows from exhaust manifold 48, through turbine 16, and exits passage 142. In this manner, the exhaust-driven turbine supplies energy to the compressor to boost the pressure and flow of air into the engine. The boost pressure, and thus engine torque, may be controlled by the rotational speed of turbine 16 which is at least partially controlled by the flow of gasses through turbine 16. Flow through the compressor may be made variable by, for example, a variable inlet device (VID) (not shown). The VID may be controlled and/or monitored via signal line 17 coupled with controller 12.

The flow of exhaust gases through turbine 16 may be further illustrated by the example embodiment of turbine 16 in FIG. 2. Turbine 16 may include a volute or housing 202 that encloses the turbine nozzle 210 and the turbine wheel 220 having turbine blades 222. For example, housing 202 may include an inlet passage 204 in communication with turbine nozzle 210. Thus, exhaust gas may flow from exhaust manifold 48, through inlet passage 204, through the turbine nozzle 210, across the turbine wheel 220 and turbine blades 222 into passage 206, and out to passage 142. Further, by varying the geometry of the turbine nozzle 210, the flow of exhaust gases, e.g. the expansion of gases, through turbine 16 may be regulated which may also control the rotational speed of turbine 16. The turbine nozzle 210 may be controlled and/or monitored via signal line 19 coupled with controller 12 (FIG. 1).

In one example, turbine nozzle 210 may be generally annular and share a central axis 230 with turbine wheel 220 and drive shaft 15. Turbine nozzle 210 may circumferentially surround the turbine wheel 220 and turbine blades 222, forming a ring around the turbine blades 222. In other words, turbine wheel 220 and turbine nozzle 210 may be coaxial and concentric.

In order to vary gas flow through a turbine nozzle, such as turbine nozzle 210 described above of FIG. 2, of a variable geometry turbine, the turbine nozzle may include a nozzle vane system comprising a plurality of sliding vanes and fixed vanes, arranged in the direct path of gas flow from the exhaust manifold to the turbine. The nozzle vane system comprises openings that may be narrowed or widened to govern the amount of flow reaching a turbine wheel based on a desired boost pressure to be delivered to an engine, such as engine 10 of FIG. 1. Different views of a plurality of fixed vanes 302 and a plurality of sliding vanes 304 of an exemplary variable geometry turbine (VGT) 260 with a nozzle vane system 300 are shown in FIGS. 3A-3C. A set of reference axes 301 is provided for comparison of views, indicating a “y” vertical direction, a “x” horizontal direction, and a “z” lateral direction. The nozzle vane system 300 includes a central axis 313 that may also be a central axis of the turbine.

The fixed vanes 302 and sliding vanes 304 of the VGT 260 are arranged in a ring with each of the fixed vanes 302 in contact with one of the sliding vanes 304. Specifically, a side wall of the fixed vanes 302 is in face-sharing contact with a side wall of the sliding vanes 304 so a plurality of vane pairs 311, comprising one of the fixed vanes 302 and one of the sliding vanes 304, is generally V-shaped, when viewed from above in FIG. 3B. The fixed vanes 302 and sliding vanes 304 may be substantially evenly spaced circumferentially around the central axis 313. A height 332, defined in the vertical direction, of the sliding vanes 304 may be less than a height 330 of the fixed vanes 302, as shown in FIG. 3A. The vane pairs 311 are aligned similarly in a same orientation along the ring of the nozzle vane system 300 so that a straight side wall 360 of each of the sliding vanes 304 forms an inner surface of the ring of vane pairs 311 with channels 370 disposed between each of the vane pairs 311. The channels 370 are openings allowing gas flow to the turbine and the amount of gas delivered to the turbine may be varied by adjusting a width of the channels 370.

Each of the sliding vanes 304 may include a set of guide tongues 322 with a top guide tongue 324 disposed on top surfaces 316 of the sliding vanes 304 and a bottom guide tongue 326 disposed on bottom surfaces 317 of the sliding vanes 304. The set of guide tongues 322 protrude outward from the top surfaces 316 and the bottom surfaces 317 of each of the sliding vanes 304 as shown in FIGS. 3A and 3C. The guide tongues 322 enable securing of the sliding vanes 304 between a set of support plates and also guide the movement of the sliding vanes 304, described further below.

The fixed vanes 302 may be held in placed by contact between top surfaces of the fixed vanes 302 and a first support plate and contact between bottom surfaces of the fixed vanes 302 and a second support plate. In this way, the fixed vanes 302 are sandwiched between the first and second support plates and immobilized by upwards and downwards, along the central axis 313, pressure from the first and second support plates. The sliding vanes 304, however, have a shorter height 332 than the fixed vanes 302 and thus have clearance between the top surfaces 316 and the first support plate and clearance between the bottom surfaces 317 and the second support plate. Thus the securing of the sliding vanes 304 between the first support plate and second support plate may depend on the insertion of the guide tongues 322 into a plurality of slots disposed in the first and second support plate as well as an actuating plate, depicted in FIGS. 4A-6.

A positioning of the sliding vanes 304 of the nozzle vane system 300 may be adjusted to control the flow of gases through the turbine nozzle. For example, in a split sliding nozzle vane turbine (SSVNT), a length of the vane pairs 311 may be adjusted to control the flow of gases through the turbine nozzle. In the example of FIGS. 3A-3C, the sliding vanes 304 may slide in a direction as indicated by arrows 305 and 307. A tapered end 303 of the sliding vanes 304 may swing through an arc described by arrow 305 and a blunt end 309 of the sliding vanes 304 may pivot, according to arrow 307, so that a rounded side of the sliding vanes 304 is slides along and maintains contact with a wall of the fixed vanes 302. The sliding vanes 304 pivot about an axis extending between the top guide tongue 324 and the bottom guide tongue 326, shown in FIG. 3C. The pivoting of the sliding vanes 304 may be actuated by an actuating plate adapted with slotsas shown in FIGS. 5A-6. The aforementioned arrangement may be herein referred to as a conventional sliding vane embodiment.

As described above, the ring of vane pairs 311 may be positioned between a set of support plates to hold the vane pairs 311 in place and direct gas flow to the channels 370 formed between the vane pairs 311. FIGS. 4A-4C are respective perspective, top, and side views illustrating a first support plate 306 and a second support plate 308 of the nozzle vane system 300 configured to sandwich the ring of vane pairs 311 of FIGS. 3A-3C. In other words, the second support plate 308 may be positioned directly on top of the nozzle vane system 300 and the first support plate 306 may be positioned directly below the nozzle vane system 300. A gap between the first support plate 306 and the second support plate 308 may be the height 330 of the fixed vanes 302, as shown in FIG. 3A. The height 332 of the sliding vanes 304 may be shorter than the height of the fixed vanes 302, providing clearance between the bottom surfaces 317 of the sliding vanes 304 and a first inner surface 314 of the first support plate 306 and clearance between the top surfaces 316 of the sliding vanes 304 and a second inner surface 312 of the second support plate 308. In this way, the sliding vanes 304 may slide freely without hindrance due to friction.

The first support plate 306 and second support plate 308 are illustrated with the second support plate 308 aligned directly above the first support plate 306 in FIG. 4A. The first support plate 306 and the second support plate 308 may both be annular with identical inner diameters and outer diameters. The dimensions of the first support plate 306 and the second support plate 308 may be adapted to allow the guide tongues 322 of the sliding vanes 304 to align with a plurality of first slots 319 in the first support plate 306 and a plurality of second slots 320 in the second support plate 308.

The plurality of first slots 319 disposed in first support plate 306 are aligned with the plurality of second slots 320 disposed in the second support plate 308 and the size of the plurality of first slots 319 may be the same as the size of the plurality of second slots 320. A thickness, as defined in the vertical direction, of the second support plate 308 may be greater than a thickness of the first support plate 306, as shown in FIGS. 4A and 4C. In one example, the first support plate 306 may be half the thickness of the second support plate 308. In other examples, the first support plate 306 may be a quarter or a third of the thickness of the second support plate 308. In addition the plurality of first slots 319 may be different in depth from the plurality of second slots 320 as described further below.

The plurality of first slots 319 of first support plate 306 may be throughholes, e.g., the plurality of first slots 319 extend entirely through the thickness of the first support plate 306 from the first inner surface 314 to a first outer surface 401. The plurality of second slots 320 of second support plate 308 are not throughholes. Instead, the plurality of second slots 320 may also be a set of top guide slots 320, that are blind holes and partially extend into the thickness of the second support plate 308 so that each slot of the set of top guide slots 320 may be a recess in the second inner surface 312 of the second support plate 308. An outer surface 403 of the second support plate 308, facing upwards and away from the first support plate 306 may have a smooth and uninterrupted surface.

The set of top guide slots 320 of the second support plate 308 may be configured so that the each top guide tongue 324 of FIGS. 3A-3B may be inserted into the set of top guide slots 320 and the movement of the sliding vanes 304 of FIGS. 3A-3B may be guided by the set of top guide slots 320. The plurality of first slots 319 of the first support plate 306 may be arranged so that each bottom guide tongue 326 of FIGS. 3A-3B may be inserted and extend through the plurality of first slots 319. The sliding vanes 304 may also include a pin 342 that is cylindrical and attached to a bottom face of bottom guide tongue 326, as shown in FIG. 6. The pin 342 is aligned axially with the vertical direction and extends across a gap 506, as shown in FIG. 5C. Each bottom guide tongue 326 may extend through the thickness of the first support plate 306 with the attached pin 342 extending beyond the outer surface 401 of the first support plate 306. With reference to FIGS. 5A-5C, the pin 342 may be inserted into a set of bottom guide slots 502 disposed in an inner surface 504 of an actuation plate 310.

The nozzle vane system 300 shown in FIGS. 5A-5C comprises the second support plate 308 and the actuation plate 310, with the first support plate 306 omitted for simplicity. The arrangement shown may include first support plate may be arranged ring of vane pairs 311 and the actuation plate 310 within the gap 506 shown in FIG. 5C. The first support plate 306 and second support plate 308 may be configured to support the ring of vane pairs 311 and maintain a position of each of the vane pairs 311 so that the sliding vanes 304 may pivot along a single plane, e.g. the plane formed by the horiztonal direction and the lateral direction.

The set of bottom guide slots 502 of the actuation plate 310 are, similar to the set of top guide slots 320, blind holes that extend partially into the thickness of the actuation plate 310. The set of bottom guide slots 502 are aligned differently from the set of top guide slots 320 (and the plurality of first slots 319 of the first support plate 306) so that the set of bottom guide slots 502 of the actuation plate 310 curve in an opposite direction from the set of top guide slots 320 of the second support plate 308. By configuring the actuation plate 310 and the second support plate 308 with blind holes rather than through holes, the actuation plate 310 and second support plate 308 may seal the nozzle vane system 300, preventing gas from leaking through slots that guide the movement of the sliding vanes 304.

The arrangement of the sliding vanes 304 in the nozzle vane system 300 is illustrated in further detail in FIG. 6. Therein, an example of a sliding vane 602 is shown in a exploded view comprising the first support plate 306 above the sliding vane 602 and the actuating plate 310 above the first support plate 306. The first support plate 306 and the actuating plate 310 may be annular in shape and have similar inner diameters and outer diameters. The nozzle vane system 300 has a central axis of rotation 601, which may also be a central axis of the turbine, about which both the first support plate 306 and the actuating plate 310 are centered. The orientation of the components of the nozzle vane system 300 is shown opposite, e.g. upside down, of the orientation shown in FIGS. 5A-5C in the vertical direction. The second support plate 308 is not included in the exploded view of FIG. 6.

The embodiment of the nozzle vane system 300 of FIG. 6, may include fixed vanes 302 (not shown in FIG. 6), first and second support plates 306, 308 arranged above and below and directly contacting top and bottom surfaces of the fixed vanes 302, the plurality of throughhole first slots 319 in the first support plate 306, and top guide slots 320 in the second support plate 308 (not shown in FIG. 6). The sliding vanes 304 of FIGS. 3A-3C may each be positioned for sliding engagement with the respective fixed vanes 302 and, each may have the set of guide tongues 322 on arranged on top surfaces 316 and on bottom surfaces 317 of the sliding vanes 304, thereof including the bottom guide tongue 326 for sliding engagement within the plurality of first slots 319 and the top guide tongue 324 for sliding engagement within the set of top guide slots 320 of the second support plate 308.

The actuating plate 310 may be disposed adjacent, and configured for movement relative to, the first support plate 306. The actuating plate 310 may have a bottom guide slot 608 of the bottom guide slots 502 (that are blind holes) that extends in a direction along a surface of the actuating plate that is different from a direction of a first slot 604 of the plurality of first slots 319 of first support plate 306. Bottom guide slot 608 and first slot 604 cross at a movable intersecting point 332, as shown in FIGS. 7A-7B, as viewed in a direction normal to the actuating plate 310. The bottom guide tongue 326 of sliding vane 602 may include the pin 342 extending into the bottom guide slot 608 at the intersection point 332 and may be movable upon movement of the actuating plate 310 relative to the first and second support plates 306, 308. In this way, the top and bottom guide slots 320, 502 in the second support plate 308 and the actuating plate 310, with reference to FIGS. 5A-5C, may tend to provide a sealed arrangement in the axial directions.

Embodiments may include the first and second support plates 306, 308 and the actuation plate 310 having disk shapes and the relative movement is a rotational movement of the actuation plate 310. The first and second support plates 306, 308 and the actuation plate 310 may be disk shaped and may have circumferential edges 336. The top guide slots 320 of the second support plate 308 and first slots 319 of the first support plate 306 may be curved and concave in a direction substantially toward the circumferential edges 336, as shown in FIG. 4A. The bottom guide slots 502 of the actuation plate 310 may be concave in a direction substantially away from the circumferential edges 336, as shown in FIGS. 5A-5B. Other shapes and directions may be used.

The sliding vane 602 is arranged so that a bottom surface 617 is facing upwards with the bottom guide tongue 326 proximal to the first support plate 306. A width 348 of the bottom guide tongue 326 is slightly less than a width of a first slot 604 of the first support plate 306. A length of the first slot 604, defined in a direction perpendicular to the width, is greater than the width 348. A height 354 of the bottom guide tongue 326 may be equal to a thickness 355 of the first support plate 306. In this way, the bottom guide tongue 326 may be inserted into the first slot 604, extending through the thickness 355 of the first support plate 306 so that the pin 342 protrudes above a top surface 606 of the first support plate 306 and extends into a bottom guide slot 608 of the set of bottom guide slots 502 disposed in an inner surface 610 of the actuating plate 310.

In this way, the bottom guide tongue 326 may track the shape of the first slot 604 and may follow an arc or curve defined by the first slot 604 of the first support plate. The top guide tongue 324, as shown in FIGS. 5A-5C, may be identical in size and shape to the bottom guide tongue 324, enabling the analogous movement of the top guide tongue 324 through an arc defined by the set of top guide slots 320 disposed in the second support plate 308.

The pin 342 may be rigidly coupled to the bottom guide tongue 326 so that the pin 342 may withstand a force applied to the side surfaces of the pin 342 resulting from contact between the side surfaces of the pin 342 and inner walls of the bottom guide slot 608 without breaking away from the bottom guide tongue 326. The movement of the sliding vane 602 along the arc of the first slot 604 may be actuated by rotation of the actuating plate 310 and a pressure exerted on the pin 342 arising from the constraint of motion within the oppositely configured bottom guide slot 608 and first slot 604.

For example, the actuating plate 310 may be rotated, by an electric motor or other actuating device, in a first direction 612, indicated by a dashed arrow, that is counterclockwise. The forces exerted and resultant motion of the sliding vane 602 is depicted in a first schematic 700 of FIG. 7A showing a top view of the pin 342 positioned in an intersection of the bottom guide slot 608 and first slot 604. As the actuating plate 310 rotates along first direction 612, the bottom guide slot 608 moves in the direction indicated by arrows 702. The pin 342, confined within the bottom guide slot 608, may experience a force 704, represented by a plurality of arrows, due to contact with a first inner wall 706 of the bottom guide slot 608. The displacement of the sliding vane 602 is restricted to a path of travel of the bottom guide tongue 326 along a length 708 of the first slot 604. The force 704 from the curved first inner wall 706 as the actuating plate 310 rotates in the first direction 612 pushes the pin 342 in the direction indicated by arrow 710. The movement of the pin 342 in the direction indicated by arrow 710, as well as the rotation of the actuating plate 310 along the first direction 612, is terminated by contact with a first end 712 of the first slot 604.

The sliding of the sliding vane 602 in the direction indicated by arrow 710 may result in a tapered end 614, as shown in FIG. 6, to swing along an arc indicated by arrow 616 which has a same trajectory as arrows 305 and 307 of FIG. 3B. The channels 370 disposed between the straight side wall 360 of the sliding vane 602 and an adjacent fixed vane of the fixed vanes 302 may be widened, allowing more gas flow through the channels 370 to reach the turbine. In this way, during engine operations requiring high boost pressures, a higher flow of pressurized air may be delivered to the engine by adjusting the nozzle vane system 300 to widen the channels 370 to meet a torque demand. Turbine spinning is increased, driving an increase in boost pressure.

To reduce the flow of gas to the turbine, the actuating plate 310 may be rotated in a second direction 618, represented by a dashed arrow, that is opposite of the first direction 612. The resulting motion is illustrated in a second schematic 750 of FIG. 7B. As the actuating plate 310 rotates along the second direction 618, the bottom guide slot 608 moves in the direction indicated by arrows 714. The pin 342, confined within the bottom guide slot 608, may experience a force 716, represented by a plurality of arrows, due to contact with a second inner wall 718 of the bottom guide slot 608. The displacement of the sliding vane 602 is restricted to a path of travel of the bottom guide tongue 326 along a length 708 of the first slot 604. The force 716 from the curved second inner wall 718 as the actuating plate 310 rotates in the second direction 618 pushes the pin 342 in the direction indicated by arrow 720. The movement of the pin 342 in the direction indicated by arrow 720, as well as the rotation of the actuating plate 310 along the second direction 618, is terminated by contact with a second end 722 of the first slot 604.

The sliding of the sliding vane 602 in the direction indicated by arrow 720 may result in the tapered end 614, as shown in FIG. 6, to swing along an arc indicated by arrow 620 which has a same trajectory as arrows 305 and 307 of FIG. 3B. The channels 370 disposed between the straight side wall 360 of the sliding vane 602 and an adjacent fixed vane of the fixed vanes 302 may be narrowed, reducing gas flow through the channels 370 to reach the turbine. In this way, during low load engine operations, a reduced flow of exhaust gas may be directed to the turbine which then lowers the boost pressure supplied by the compressor by adjusting the nozzle vane system 300 to narrow the channels 370.

In other embodiments of the nozzle vane system 300, a turbine nozzle 210 wherein an engine control unit 12, for example the engine control unit 12 illustrated in FIG. 1, may be configured to provide signals and/or power to effect rotational movement of the actuation plate in accordance with engine conditions. The actuating plate 310 may be movable in a rocking motion to move the actuating plate 310 in a first direction 612 to increase flow of exhaust gas through the turbine nozzle, and to move the actuating plate 310 in a second direction 618 opposite the first direction to provide increased flow of exhaust gas through the turbine nozzle to the turbine. One or more mechanical means may be used to move the actuating plate 310, and/or one or more control systems may be used. For example, moving mechanisms such as a reciprocation mechanism such as a linkage arrangement, or cam arrangement, or rocker arm, and the like.

A variable geometry turbine with sliding vane and fixed vane can significantly improve turbine low end efficiency to improve engine transient response and fuel economy during a drive cycle. However, a robust actuation is needed for such systems. In the present disclosure, a variable geometry turbine actuation system configured with fixed vanes and sliding vanes is described. The actuation system may be applied to any variable geometry turbine with fixed vanes and sliding vanes.

The system comprises three plates with the sliding vane and the fixed vane installed between two plates. There is clearance between the sliding vanes and the two plates, but there is no clearance between the fixed vanes and the two plates, named as support plates. Guide slots are arranged on the two support plates. The guide slots may be blind holes on one plate (bottom) and throughholes on the other plate (top). Another plate, named as actuation plate, is installed on the top of the top support plate. On the actuation plate, guide slots are also manufactured. The direction of guide slots on the actuation slot is different from that of the slots on the supporting plates. Guide tongues are coupled a top surface and a bottom surface of the sliding vanes. On the bottom, a bottom guide tongue is installed inside the guide slot of the bottom support plate. On the top, a top guide tongue is installed inside the throughhole of the top support plate a pin extending from the top guide tongue extends into the guide slots of the actuation plate. The rotating of the actuation plate will have force acting on the pin of the sliding vane. Then the sliding vane may slide along the guide slots on the support plates to open or close the flow passages. The rotating of the actuation plate may be driven by a hydraulic system, motor or other similar devices. The arrangement of guide slots rather than through holes in the bottom support plate and the actuation plate prevents gas leakage through the nozzle vane system out of the turbine nozzle. The width of flow channels through the nozzle vane system is adjusted by the positioning of the sliding vanes, thereby controlling the amount of gas delivered to the turbine driving the compressor and thus regulating the boost pressure supplied to the engine. By restricting the movement of the sliding vanes to the guiding slots, undesired displacement of the sliding vanes is avoided, improving turbocharger efficiency by enabling control of boost pressure responsive to engine operation without loss of exhaust pressure due to leakage.

Now turning to FIG. 8, example routines for controlling the flow of exhaust gas to an exhaust turbine for a boosted engine is described. Exhaust gas flow may be directed to a variable geometry turbine of a turbocharger through a turbine nozzle adapted with a nozzle vane system, such as the nozzle vane system 300 of FIGS. 3A-6, in response to an increase or decrease in torque demand. By rotating an actuating plate of the nozzle vane system, the gas flow to the turbine may be increased or decrease in response to torque demand and engine speed/load. Instructions for carrying out method 800 and the rest of the methods included herein may be executed by a controller based on instructions stored on a memory of the controller and in conjunction with signals received from sensors of the engine system, such as the sensors described above with reference to FIG. 1. The controller may employ engine actuators of the engine system to adjust engine operation, according to the methods described below.

At 802, the operating conditions of the engine may be estimated and/or measured. These may include, for example, engine speed and load, torque demand, boost pressure, MAP, etc. at 804 is may be determined whether the torque supplied, via boosted air delivered from the turbocharger to the engine, is sufficient to accommodate the torque demanded, as inferred by detection of pedal position by a pedal position sensor. If the torque, or boost pressure, supply is does not match the demand, the routine at 806 then determines if the supply of torque greater than the demand. If the torque supply does not exceed the demand, turbocharger operation continues to 808 under current conditions, e.g., current positioning of sliding vanes in the nozzle vane system. Current turbine and compressor rpm. If, however, an excess of torque is supplied compared to demand, the method may proceed to 818, described further below.

Returning to 804, if the torque supply does not meet the demand and an increase in boost pressure is desired, the routine continues to 810, sending instructions to the actuator of the nozzle vane system to rotate an actuating plate in a first direction. The rotation of the actuating plate applies a force to each pin of a plurality of pins inserted in guiding slots of the actuating plate. The pins are coupled to first guiding tongues of sliding vanes. The guiding slots in the actuating plate are angled in a opposite direction relative to guiding slots in a second support plate as well as a throughhole slots in a first support plate. The arrangement of the sliding vanes within an intersection of the guiding slots of the actuating plate and guiding slots of the second support plate (which is also an intersection of the guiding slots of the actuating plate and the throughhole slots of the first support plate) results in exertion of force on the pins as the actuating plate is rotated. The pressure exerted on the pins due to contact with first inner walls of the guiding slots of the actuation plate moves the pins, and the sliding vanes, along an arc described by a length of the guiding slots in the actuating plate. The direction of movement of the sliding vanes is restricted to a path defined by the insertions of second guiding tongues into the guiding slots in the second support plate and first guiding tongues into the throughhole slots in the first support plate, resulting in the sliding of the sliding vanes so that a flow channel between the sliding vanes and adjacent fixed vanes is widened.

The amount that the flow channel is widened may be based on a amount of torque requested, as indicated by pedal position. For example, the more the pedal is depressed, the further the actuating plate is rotated in the first direction, shifting the sliding vane to increase the width of the flow channel. As an example, if the pedal is depressed to a maximum, the actuating plate may be rotated along the first direction to slide the sliding vanes until the movement of the sliding vanes is halted by contact between the first guiding tongues of the sliding vanes with first ends of the throughhole slots of the first support plate and contact of the second guiding tongues of the sliding vanes with first ends of the guiding slot of the second support plate. By rotating the actuating plate in the first direction, the flow channels may be widened, allowing increased gas flow to the turbine.

At 812, the widths of a plurality of flow channels of the nozzle vane system are increased and higher gas flow to the turbine is enabled at 814. This results in increase boosting of air by the compressor, thus delivering more torque to the engine. The method, at 816, determines if the torque demand is less than the supply of torque provided by the turbocharger. If the torque demand is not less than the supply, the routine returns to 812 to continue flowing gas through widened flow channels. If, however, the torque demand is detected to be lower than the supply, the actuator the routine proceeds to 818, sending instructions to the actuator to rotate the actuating plate in a second direction.

The rotation of the actuating plate applies a force to the pins inserted in the guiding slots of the actuating plate and coupled to the first guiding tongues of the sliding vanes. The arrangement of the sliding vanes in intersections of the guiding slots of the actuating plate and guiding slots of the second support plate (which are also intersections of the guiding slots of the actuating plate and the throughhole slots of the first support plate) results on the exertion of force on the pins as the actuating plate is rotated. The pressure exerted on the pins due to contact with second inner walls of the guiding slots of the actuation plate moves the pins, thereby moving the sliding vanes, along an arc described by the length of the guiding slots in the actuating plate in an opposite direction from that described above for increasing flow to the turbine. The direction of movement of the sliding vanes is restricted to a path defined by insertion of second guiding tongues into the guiding slots in the second support plate and the first guiding tongues into the throughhole slots in the first support plate, resulting in the sliding of the sliding vanes so that a flow channel between the sliding vanes and adjacent fixed vanes is narrowed.

The amount that the flow channel is narrowed is based on a amount of torque requested, as indicated by pedal position. For example, the more the pedal is released, the further the actuating plate is rotated in the second direction, shifting the sliding vanes to decrease the width of the flow channels. As an example, if the pedal is fully released, the actuating plate may be rotated along the second direction to slide the sliding vanes until the movement of the sliding vanes is halted by contact between the first guiding tongues of the sliding vanes with second ends of the throughhole slots of the first support plate and contact between the second guiding tongues of the sliding vanes with second ends of the guiding slots of the second support plate. By rotating the actuating plate in the second direction, the flow channels may be narrowed, reducing gas flow to the turbine.

At 820, the widths of a plurality of flow channels of the nozzle vane system are decreased and reduced gas flow is delivered to the turbine at 822 of the routine. Spinning of the compressor is decreased, resulting in lowered boost pressure. In this way, a nozzle vane system of a variable geometry turbine may control the flow of exhaust gas to a boosted engine. The adjustment of the nozzle vane system to widen or narrow flow channels in the nozzle vane system may be based on a requested amount of torque. To increase boost pressure, an actuating plate of the nozzle vane system may be rotated in a first direction that pivots a ring of sliding vanes to increase the flow channel widths so that more gas is delivered to the turbine. To decrease boost pressure, the actuating plate is rotated in a second, opposite direction that restricts flow through the flow channels. By configuring the actuating plate disposed with slots angled differently than slots in a pair of supporting plates sandwiching a ring of alternating sliding vanes and fixed vanes, a force is exerted on a pin coupled to each of the sliding vanes. The force applied to the pin guides the movement of each of the sliding vanes along an arc defined by the slots of the supporting plates so that a flow channel adjacent to each sliding vane is narrowed or widened depending on the direction of movement along the arc. By configuring the actuating plate and a bottom support plate of the set of support plates with guide slots that are blind holes, gas leakage through the slots and out of the nozzle vane system is avoided. The technical effect of adapting a turbine nozzle with the nozzle vane system is that turbocharger efficiency and vehicle fuel economy is improved.

FIGS. 1-7B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As one embodiment, a turbine nozzle includes fixed vanes; first and second support plates fixed to opposite ends of the fixed vanes, throughslot guide slots in the first support plate, and blind guide slots in the second support plate; sliding vanes each positioned for sliding engagement with the respective fixed vanes, each having guide tongues on opposite ends thereof including a first guide tongue for sliding engagement within respective throughslot guide slots and a second guide tongue for sliding engagement within respective blind guide slots; an actuation plate disposed adjacent, and configured for movement relative to, the first support plate, and having blind actuation slots that extend in directions different from directions of the guide slots and that cross over the guide slots at movable intersecting points as viewed in a direction normal to the actuation plate; and the first guide tongues each including an actuating pin extending into respective actuation slots at the intersecting points and movable upon movement of the actuation plate relative to the support plates. In a first example of the turbine nozzle, the first and second support plates and the actuation plate are disk shaped and the relative movement is rotational movement of the actuation plate. A second example of the turbine nozzle optionally includes the first example and further includes wherein the support plates and the actuation plate are disk shaped having circumferential edges, and wherein the guide slots are curved guide slots being concave in a direction substantially toward the circumferential edges; and the actuation slots are curved actuation slots being concave in a direction substantially away from the circumferential edges. A third example of the turbine nozzle optionally includes one or more of the first and second examples, and further includes an engine control unit configured to provide signals and/or power to effect rotational movement of the actuation plate in accordance with engine conditions. A fourth example of the turbine nozzle optionally includes one or more of the first through third examples, and further includes, wherein the actuation plate is movable in a rocking motion to move the actuating plate in a first direction to restrict flow of exhaust gas through the turbine nozzle, and to move the actuating plate in a second direction opposite the first direction to provide increased flow of exhaust gas through the turbine. A fifth example of the turbine nozzle optionally includes one or more of the first through fourth examples, and further includes, wherein the fixed vanes and the sliding vanes are substantially evenly spaced circumferentially around a central axis. A sixth example of the turbine nozzle optionally includes one or more of the first through fifth examples, and further includes, wherein the central axis is substantially coincident with a turbine central axis.

As another embodiment, a method of adjusting a variable geometry turbine (VGT) includes fixing a number of fixed vanes between first and second support plates; positioning the same number of sliding vanes for sliding engagement with each respective fixed vane; positioning a first tongue extending from each sliding vane through respective guide slots defined through the first support plate; arranging an actuation plate having blind actuation slots defined therein adjacent the first support plate for movement relative thereto and covering the guide slots of the first support plate therewith; positioning a pin extending from each sliding vane through respective actuation slots formed in the actuation plate at respective intersection points, the intersection points defined as locations wherein the actuation slots cross the guide slots; and rotating the actuation plate and causing actuation slots to rotate about a center line, and causing the intersecting points to move along a path defined by the guide slots and providing a force on the pin and effecting a sliding of each sliding vane relative to each respective fixed vane. In a first example of the method, fixing a number of fixed vanes between first and second support plates includes forming a discontinuous pathway for engine exhaust to pass between the fixed vanes; and wherein the rotating the actuation plate includes effecting selective modification of the pathway of exhaust gas flow through the pathway and toward turbine blades. A second example of the method optionally includes the first example and further includes positioning a second tongue extending from each sliding vane into respective second guide slots, being blind slots, formed in the second support plate. A third example of the method optionally includes one or more of the first and second examples, and further includes wherein the rotating of the actuation plate is controlled by an engine control unit. A fourth example of the method optionally includes one or more of the first through third examples, and further includes, wherein the rotating of the actuation plate includes rocking the actuating plate in a first direction to restrict flow of exhaust gas through the turbine, and rocking the actuating plate in a second direction to provide increased flow of exhaust gas through the turbine. A fifth example of the method optionally includes one or more of the first through fourth examples, and further includes, wherein the support plates and the actuation plate are disk shaped having circumferential edges, the method further comprising: forming the guide slots as curved guide slots being concave in a direction substantially toward the circumferential edges; and forming the actuation slots as curved actuation slots being concave in a direction substantially away from the circumferential edges. A sixth example of the method optionally includes one or more of the first through fifth examples, and further includes, forming the fixed vanes and the sliding vanes to have curved contacting sliding surfaces; and forming the guide slots as curved guide slots being curved substantially similar to the curved contacting sliding surfaces. A seventh example of the method optionally includes one or more of the first through sixth examples, and further includes, configuring an engine control system for: receiving engine operating characteristics from one or more sensors operatively disposed within an engine, and effecting movement of the actuation plate based on the sensed engine operating characteristics. An eighth example of the method optionally includes one or more of the first through seventh examples, and further includes, wherein the support plates and the actuation plate are disk shaped, the method further comprising: fitting the actuation plate for substantial sealing engagement against the first support plate.

As another embodiment, a turbine nozzle includes a first support plate having a first guide slot passing therethrough, the first guide slot extending in a first direction; a second support plate substantially parallel with and fixed to the first support plate with a fixed vane; an actuating plate adjacent the first support plate and having a blind actuating slot formed therein, the actuating slot extending in a second direction forming an angle with first guide slot, the first guide slot and the actuating slot crossing at a movable intersecting point as viewed in a direction normal to the actuating plate, the movement thereof effected by a relative movement between the actuating plate and first support plate; and a sliding vane between the first and second support plates in sliding engagement with the fixed vane and having a protrusion with a first first tongue and a pin, the first tongue extending through the first guide slot for sliding engagement therein, and the pin extending into the actuating slot at the movable intersection point and movable with the intersection point in accordance with the respective relative movement between the actuating plate and first support plate. As a first example, a turbine nozzle includes the first tongue has a width less than the thickness of the first guide slot, and a length greater than the width, the pin is cylindrical and extends from a top of the first protrusion part and is configured for forced contact with the inner walls of the actuating slot. A second example of the turbine nozzle optionally includes the first example, and further includes wherein the second support plate includes a second guide slot being a blind slot and substantially parallel with the first guide slot, and wherein the sliding vane has a second tongue extending from an opposite end of the slinging vane and in sliding engagement with the second guide slot. A third example of the turbine nozzle optionally includes one or more of the first and second examples, and further includes, further comprising multiple sliding vanes configured similarly to said sliding vane each configured with a similarly configured first tongue, pin and second tongue and each respectively disposed for sliding engagement within multiple similarly configured first and second guide slots and each including similarly configured second protrusion parts respectively disposed for forced sliding engagement within similarly configured multiple blind actuation slots.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A turbine nozzle comprising:
fixed vanes;
first and second support plates fixed to opposite ends of the fixed vanes, throughslot guide slots in the first support plate, and blind guide slots in the second support plate;
sliding vanes each positioned for sliding engagement with the respective fixed vanes, each having guide tongues on opposite ends thereof including a first guide tongue for sliding engagement within respective throughslot guide slots and a second guide tongue for sliding engagement within respective blind guide slots;
an actuation plate disposed adjacent, and configured for movement relative to, the first support plate, and having blind actuation slots that extend in directions different from directions of the guide slots and that cross over the guide slots at movable intersecting points as viewed in a direction normal to the actuation plate; and
the first guide tongues each including an actuating pin extending into respective actuation slots at the intersecting points and movable upon movement of the actuation plate relative to the support plates.

2. The turbine nozzle of claim 1, wherein the first and second support plates and the actuation plate are disk shaped and the relative movement is rotational movement of the actuation plate.

3. The turbine nozzle of claim 1, wherein, the support plates and the actuation plate are disk shaped having circumferential edges, and wherein the guide slots are curved guide slots being concave in a direction substantially toward the circumferential edges; and the actuation slots are curved actuation slots being concave in a direction substantially away from the circumferential edges.

4. The turbine nozzle of claim 1, further comprising an engine control unit configured to provide signals and/or power to effect rotational movement of the actuation plate in accordance with engine conditions.

5. The turbine nozzle of claim 1, wherein the actuation plate is movable in a rocking motion to move the actuating plate in a first direction to restrict flow of exhaust gas through the turbine nozzle, and to move the actuating plate in a second direction opposite the first direction to provide increased flow of exhaust gas through the turbine.

6. The turbine nozzle of claim 1, wherein the fixed vanes and the sliding vanes are substantially evenly spaced circumferentially around a central axis.

7. The turbine nozzle of claim 6, wherein the central axis is substantially coincident with a turbine central axis.

8. A method of adjusting a variable geometry turbine (VGT) comprising:
fixing a number of fixed vanes between first and second support plates;
positioning the same number of sliding vanes for sliding engagement with each respective fixed vane;
positioning a first tongue extending from each sliding vane through respective guide slots defined through the first support plate;
arranging an actuation plate having blind actuation slots defined therein adjacent the first support plate for movement relative thereto and covering the guide slots of the first support plate therewith;
positioning a pin extending from each sliding vane through respective actuation slots formed in the actuation plate at respective intersection points, the intersection points defined as locations wherein the actuation slots cross the guide slots; and
rotating the actuation plate and causing actuation slots to rotate about a center line, and causing the intersecting points to move along a path defined by the guide slots and providing a force on the pin and effecting a sliding of each sliding vane relative to each respective fixed vane.

9. The method of claim 8, wherein
the fixing a number of fixed vanes between first and second support plates includes forming a discontinuous pathway for engine exhaust to pass between the fixed vanes; and
wherein the rotating the actuation plate includes effecting selective modification of the pathway of exhaust gas flow through the pathway and toward turbine blades.

10. The method of claim 8, further comprising positioning a second tongue extending from each sliding vane into respective second guide slots, being blind slots, formed in the second support plate.

11. The method of claim 8, wherein the rotating of the actuation plate is controlled by an engine control unit.

12. The method of claim 8, wherein the rotating of the actuation plate includes rocking the actuating plate in a first direction to restrict flow of exhaust gas through the turbine, and rocking the actuating plate in a second direction to provide increased flow of exhaust gas through the turbine.

13. The method of claim 8, wherein the support plates and the actuation plate are disk shaped having circumferential edges, the method further comprising:
forming the guide slots as curved guide slots being concave in a direction substantially toward the circumferential edges; and
forming the actuation slots as curved actuation slots being concave in a direction substantially away from the circumferential edges.

14. The method of claim 8, further comprising:
forming the fixed vanes and the sliding vanes to have curved contacting sliding surfaces; and
forming the guide slots as curved guide slots being curved substantially similar to the curved contacting sliding surfaces.

15. The method of claim 8, further comprising:
configuring an engine control system for:
receiving engine operating characteristics from one or more sensors operatively disposed within an engine, and
effecting movement of the actuation plate based on the sensed engine operating characteristics.

16. The method of claim 8, wherein the support plates and the actuation plate are disk shaped, the method further comprising: fitting the actuation plate for substantial sealing engagement against the first support plate.

17. A turbine nozzle comprising:
a first support plate having a first guide slot passing therethrough, the first guide slot extending in a first direction;
a second support plate substantially parallel with and fixed to the first support plate with a fixed vane;
an actuating plate adjacent the first support plate and having a blind actuating slot formed therein, the actuating slot extending in a second direction forming an angle with first guide slot, the first guide slot and the actuating slot crossing at a movable intersecting point as viewed in a direction normal to the actuating plate, the movement thereof effected by a relative movement between the actuating plate and first support plate; and
a sliding vane between the first and second support plates in sliding engagement with the fixed vane and having a protrusion with a first first tongue and a pin, the first tongue extending through the first guide slot for sliding engagement therein, and the pin extending into the actuating slot at the movable intersection point and movable with the intersection point in accordance with the respective relative movement between the actuating plate and first support plate.

18. The turbine nozzle of claim 17, wherein the first tongue has a width less than the thickness of the first guide slot, and a length greater than the width, the pin is cylindrical and extends from a top of the first protrusion part and is configured for forced contact with the inner walls of the actuating slot.

19. The turbine nozzle of claim 17, wherein the second support plate includes a second guide slot being a blind slot and substantially parallel with the first guide slot, and wherein the sliding vane has a second tongue extending from an opposite end of the slinging vane and in sliding engagement with the second guide slot.

20. The turbine nozzle of claim 19, further comprising multiple sliding vanes configured similarly to said sliding vane each configured with a similarly configured first tongue, pin and second tongue and each respectively disposed for sliding engagement within multiple similarly configured first and second guide slots and each including similarly configured second protrusion parts respectively disposed for forced sliding engagement within similarly configured multiple blind actuation slots.
